(19) United States
(12) Patent Application Publication
(10) Pub. No.: US 2025/0206405 A1
(43) Pub. Date: Jun. 26, 2025

(54) A CYCLE FOR CARRYING CARGO

(71) Applicant: TOMCAT SPECIAL NEEDS INNOVATION LIMITED, Hucclecote, Gloucester, Gloucestershire (GB)

(72) Inventor: Robert William Frank Griffin, Minchinhampton, Stroud, Gloucestershire (GB)

(21) Appl. No.: 18/845,964

(22) PCT Filed: Mar. 13, 2023
(86) PCT No.: PCT/GB2023/050586

§ 371 Date: Sep. 11, 2024

(30) Foreign Application Priority Data
Mar. 11, 2022 (GB) 2203444.1
Jan. 5, 2023 (GB) 2300151.4

(51) Int. Cl. B62K 7/02; B62J 9/27; B62K 5/06; B66F 3/44

(52) U.S. Cl. CPC B62K 7/02; B62J 9/27; B62K 5/06; B66F 3/44

(57) ABSTRACT

A cycle for carrying cargo comprising a cycle frame having a front section mounting a steerable front wheel and a U-shaped rear section having a head member and side members with at least one rear wheel being mounted to each side member. A space can be disposed between the side members and rear wheels. A powered lifting means can be provided along the side members and include a movable lifting apparatus. The lifting means can be configured to move the movable lifting apparatus upwardly and/or downwardly with respect to the U-shaped rear section for engaging with and lifting cargo positioned in the space.

The present invention relates to a cycle and more particularly but not exclusively to a tricycle for carrying cargo.

### BACKGROUND TO THE INVENTION

It is known to utilise a pedal powered cycle for transporting a load or some cargo. For example, trishaws are three-wheeled cycle rickshaws well known for carrying people. Usually, the trishaw has two rear wheels with a cargo area between, a forward seat for the cyclist and a front steered wheel. A chain drive between the pedals provides motive power to the rear wheels in conventional manner.

A problem with current devices, is that they tend to be very heavy. The cargo is usually placed substantially in front of the rear wheels, with significant weight on the front wheel. This makes steering more challenging, but also increases the weight passing through the frame of the cycle from rear to front. Consequently, a strong heavy frame is required. This defeats a primary objective of pedal power, namely, to provide a lightweight cycle, which can be pedalled. Even if electric power assistance is utilised, it is still highly desirable to reduce the weight of the cycle to optimise performance.

Cargo is often lifted onto the cargo area of a cycle manually, but it is advantageous to be able to load heavier and larger loads, for example, cargo or transport boxes or containers designed to be transported by the cycle using a lifting device. It would be desirable to be able to both lift and carry palletised items and wheeled cages.

US 2020/0307733 A1 (RYTLE) proposes a solution in which a vertically extending frame is positioned between the rider position and the cargo position. A wheeled cargo box can be pushed into the cargo area and engaged with receiving elements of a lifting device, provided in the vertical frame. The receiving elements appear from the corresponding RYTLE website to engage in cut-outs in the cargo box. A ratchet device can then be used to drive the receiving elements upwardly, thereby lifting the cargo box off the ground and into an elevated position for transport.

A serious problem of this device is that the frame has to be very strong, and consequently heavy, to support the lifting mechanism and the loaded cargo box. The weight is also supported from a high and therefore, unstable position relative to the axle height of the wheels. The weight is also concentrated directly behind the rider, thereby requiring a very strong and heavy cycle frame.

It is an object of the present invention to reduce or substantially obviate the aforementioned problems.

### STATEMENT OF INVENTION

According to a first aspect of the present invention, there is provided a cycle for carrying cargo comprising:
a cycle frame having a front section mounting a steerable front wheel and a U-shaped rear section having a head member and side members, with at least one rear wheel being mounted to each side member,
a space disposed between the side members and rear wheels, and
powered lifting means provided along the side members and including a movable lifting apparatus, the lifting means being configured to move the movable lifting apparatus upwardly and/or downwardly with respect to the U-shaped rear section for engaging with and lifting cargo positioned in the space.

Advantageously, the lifting means is positioned close to the rear wheels at a relatively low position. This makes for good distribution of the cargo or load and improves the balance of the cycle. The powered lifting means enables the cargo to be loaded and unloaded on the cycle without requiring a person to manually move the cycle into a raised and/or lowered position. It also allows different types of cargo to be carried by the cycle, such as cargo pods, transport boxes or containers, pallets or wheeled cages.

Each side member of the U-shaped rear section may have a first end connected to an end of the head member of the U-shaped rear section and a second end located opposite the first end. The second end of each side member may be chamfered at an angle. This presents a “birdmouth” entrance towards the rear of the cycle, which assists in guiding the cargo between the side members. The chamfered ends of the side members help centralise the horizontal approach of the cargo towards the U-shaped rear section.

The movable lifting apparatus may include a pair of movable side bars. The movable side bars may be provided and lie substantially above the side members of the U-shaped rear section. In other words, each side member may overlie a respective side member of the U-shaped rear section, in which a length of the side bars extends in a direction parallel to a length of the side members of the U-shaped rear section. The movable side bars may have substantially the same length as the side members of the U-shaped rear section.

Advantageously, the movement of the side bars upwardly and/or downwardly with respect to the U-shaped rear section enables cargo to be moved to the raised or lowered positions by the cycle. For example, when a cargo such as a cargo pod is pushed into the space between the side members of the U-shape rear section, side rails of the cargo pod may overlie the side bars of the movable lifting apparatus. This allows the cargo pod to move with the movement of the side bars and be lifted to the raised position for transport and be set down to the lowered position after transport.

The movable side bars may connect to each other to form a movable U-shaped frame. This further ensures that the movable side bars move away from or towards the side members of the U-shaped rear section, or upwardly or downwardly with respect to the U-shaped rear section together so that the cargo can be lifted or set down evenly by the movable side bars.

An end of each movable side bar may be chamfered downwardly at an angle from front to rear. Each chamfered end of the movable side bars may be disposed next to a respective second end of the side members of the U-shaped rear section. The chamfered ends of the movable side bars help guide the vertical approach of the cargo such as a cargo pod towards the U-shaped rear section.

In addition, or alternatively, the movable lifting apparatus may include a supporting surface. The supporting surface may be disposed or may lie substantially below the U-shaped rear section. The movement of the supporting surface upwardly and/or downwardly with respect to the U-shaped rear section enables cargo lying or resting on the supporting surface to be lifted or lowered by the cycle. For example, when a cargo such as a pallet or a wheeled cage is placed or pushed on the supporting surface, the movement of the supporting surface enables the pallet or cage to be moved to the raised position for transport and the lowered position after transport.

The supporting surface may comprise a lower U-shaped frame having a head member and side members. Each side member of the lower U-shaped frame may have a first end connected to an end of the head member of the lower U-shaped frame and a second end located opposite the first end. Each side member of the lower U-shaped frame may lie below a respective side member of the U-shaped rear section such that a length of the side members of the lower U-shaped frame extends in a direction parallel to a length of the side members of the U-shaped rear section.

The side members of the U-shaped rear section may have substantially the same length as the side members of the lower U-shaped frame of the supporting surface. However, in other embodiments, the side members of the lower U-shaped frame of the supporting surface may have a longer length than the side members of the U-shaped rear section.

The supporting surface may further comprise a pair of side supporting elements. Each side supporting element may be connected to a respective side member of the lower U-shaped frame. Each side supporting element may be welded onto the respective side member of the lower U-shaped frame. A length of each side supporting element may extend in a direction parallel to the length of the side members of the lower U-shape frame. The side supporting elements may have substantially the same length as the side members of the lower U-shaped frame.

A second end of each side member of the lower U-shaped frame may be chamfered at an angle. This presents a “birdmouth” entrance towards the rear of the cycle similar to the chamfered ends of the side members of the U-shaped rear section, which assists in guiding the cargo within the space between the side members of the U-shaped rear section. The chamfered ends of the side members of the lower U-shaped frame help centralise the horizontal approach of the cargo towards the U-shaped rear section.

An end of at least one side supporting element may be chamfered downwardly at an angle from front to rear forming a side ramp. More preferably, the ends of both side supporting elements are chamfered or tapered downwardly to form ramps. The chamfered end of the or each side supporting element may be disposed next to the chamfered end of the or the respective side member of the lower U-shaped frame. This enables cargo to be easily pushed on the side supporting elements of the supporting surface, for example when the cargo is wheeled onto the side supporting elements, without a person needing to lift the cargo.

The supporting surface may further comprise a front supporting element. The front supporting element may be connected to the head member of the lower U-shaped frame, for example, by welding. The front supporting element may be disposed between the side supporting elements. A length of the front supporting element may extend in a direction parallel to a length of the head member of the lower U-shaped frame. This allows a front part of the cargo to be further supported by the cycle.

The side supporting elements and/or the front supporting element may be welded onto the lower U-shaped frame to form a single unit.

The supporting surface may include a platform. The platform may be pivotally or hingedly connected to the head member of the lower U-shaped frame. The platform may be movable between an operative position and a folded position. The platform may rest or lie on the side and/or front supporting elements, when in the operative position. The platform enables cargo that cannot be wheeled or rested onto the supporting elements or cargo that requires further support to be loaded on the cycle.

The platform may comprise a first platform section and a second platform section. A first end of the first platform section may be pivotally or hingedly connected to the head member of the lower U-shaped frame. The first platform section and the second platform section may be pivotally or hingedly connected to each other. In other words, a second end of the first platform section may be pivotally or hingedly connected to a first end of the second platform section.

The first and second platform sections may rest or lie on the side and/or front supporting elements, when in the operative position. In the folded position, the first and second platform sections may be disposed between the first ends of the side members of the lower U-shaped frame. The first and second platform sections may extend substantially perpendicularly to the length of the side members of the lower U-shaped frame, when in the folded position.

When moving from the operative to folded position, the first platform section may rotate about the pivot in a clockwise direction, when viewed from the right-hand side of the cycle, by substantially about 90 degrees. The second platform section, when viewed from the same side, may rotate in the opposite direction about the pivot between the first and second platform sections.

The first platform section and the second platform section may rotate back in the opposite directions when moving from the folded to operative position.

Advantageously, this enables the platform to be moved out of the way if it is not required for lifting cargo, for example when the cargo can already be wheeled or rested on the supporting elements.

The platform may include a ramp. The ramp may be connected to a second end of the second platform section. This enables cargo to be easily pushed on the platform or supporting surface, without a person needing to manually lift the cargo onto the platform.

The platform and/or the ramp may include a handle. The handle may be in a form of an aperture.

The handle may be provided in the central portion of the ramp. This allows a person to pull or push the platform into the operative position or folded position.

The powered lifting means may be a plurality of jacks. At least one jack may be provided on each side member of the U-shaped rear section. The jacks allow cargo, for example a cargo pod containing a heavy load such as humans, animals, organic or non-organic materials, a pallet or a wheeled cage to be lifted to a raised position and carried by the cycle for transport. Furthermore, the jacks also allow for the cargo to be set down from the raised position to a lowered position typically, after transport. In other words, the jacks may move between a raised position and a lowered position for raising and lowering the cargo.

Preferably, four jacks are provided, two jacks being disposed on each side member of the U-shaped rear section. A first jack of each side member may be disposed at the first end of the side member of the U-shaped rear section and a second jack of each side member may be disposed at the second end of the side member of the U-shaped rear section. This allows substantially even loading on each side member.

More than four jacks may be provided. When there are more than two jacks disposed on each side member, the jacks on each side member may be equally spaced out from each other. For example, three jacks may be disposed on each side member where a first jack of each side member is disposed at the first end of the side member, a second jack of each side member is disposed at the second end of the side member and a third jack of each side member is disposed in the centre of the side member.

Alternatively, the third jack may be disposed offset from the centre of the side member where the jacks are not equally spaced out on each side member.

Each jack on a side member of the U-shaped rear section may be aligned with its respective jack on the other side member. This allows the jacks to support the movable side bars and the supporting surface evenly.

The jacks may connect the movable side bars and/or the supporting surface to the U-shaped rear section. This allows the movable side bars and/or the supporting surface to form part of the U-shaped rear section. Furthermore, the jacks may drive the movable side bars and/or supporting surface away from or towards the side members of the U-shaped rear section, or upwardly or downwardly with respect to the U-shaped rear section for lifting or setting down the cargo or load.

The jacks may move in a synchronised manner to drive the movable side bars and/or supporting surface upwardly or downwardly with respect to the U-shaped rear section. This allows all the jacks to move together so that the side bars and/or supporting surface can move upwardly or downwardly with respect to the side members of the U-shaped rear section at the same time allowing the cargo to be lifted or set down evenly.

Each jack may be screw type, lever or equivalent with a caveat that they move e.g., raise and lower, coincidentally or in a synchronised manner. The jacks may be operated and interconnected by hydraulic means, electric means or various mechanical means such as mechanical links, chain drive, shaft drive, rack and pinion drive or any combination of these.

The jacks may be interlinked shaft driven jacks where the jacks are driven through a worm and wheel drive. This may provide compactness to the cycle and may improve safety since the jacks cannot descend under load.

Preferably, the jacks are screw jacks driven by toothed belt or sprockets and chains. To achieve the synchronisation of the movement of the jacks, further chains and sprockets may be provided. The chains and sprockets may attach to the jacks on the side members. In this way, the rotation of a jack or the movement of chains may cause all the jacks to move in unison e.g., raising or lowering of the jacks.

The screw jacks or screw threaded rods may extend above and below the side members of the U-shaped rear section. A first end of each screw threaded rod may be connected to a side bar of the movable lifting apparatus. A second end of the screw threaded rod may be connected to the supporting surface of the movable lifting apparatus. The second end of the screw threaded rod may be connected to a side member of the lower U-shaped frame of the supporting surface. The connection of the screw threaded rod allows the movable lifting apparatus to move with the movement of the jacks.

The pitch may be around 5 mm for each screw jack. The helix may be 4 degrees for each screw jack. This can prevent the screw jacks or the screw threaded rods from being subjected to backwards rotation under load.

A housing may be provided and disposed between each movable side bar and each side member of the U-shaped rear section. This enables part of the jacks and the tooth belt or sprocket and chains to be covered and protected, for example, to prevent build-up of dirt or dust. In addition of alternatively, housing may be provided and disposed between the side members of the U-shaped rear section and the supporting surface such as the side members of the lower U-shaped frame.

The powered lifting means i.e., the jacks may be driven by a lifting actuator such as a motor. The jacks may be driven by a linear motor, or the jacks may be driven by a hand drive.

The motor may operate between limit switches i.e., overload switch and latch switch or stops further described below. Piston ends of the motor may be connected to a chain connecting the jacks on both side members of the U-shaped rear section. Advantageously, the motor actuates the movement of the jacks and allows the jacks to be controlled.

The chain connecting the jacks on both sides members may be adjustable on its non-loaded side. This allows the slack of the chain to be adjusted as desired.

Latching means may be provided to secure the cargo such as a cargo pod in the raised position. The latching means may comprise a latch pawl and a latch.

The latch pawl may be provided on one end of the piston of the motor. The piston of the motor may move in a direction towards the latch on the U-shaped rear section. The latch pawl may engage with the latch to secure the cargo in the raised position and hold the jacks in place. The latch pawl and the latch together may act as a locking means for holding the jacks and cargo in the raised position during transit of the cargo. Advantageously, this allows the cargo to be kept in the raised position from the ground during transport so that it can be carried by the cycle.

The angle of contact faces of the latch pawl and latch may be such that when the latch pawl and latch are engaged under load, it would be extremely difficult or impossible to manually disengage the latch with the latch pawl. This provides a safety feature to the cycle and allows the position of the jacks to be maintained.

The latch may include a handle. The actuation of the handle enables the engagement of the latch pawl and the latch to be released for lowering of the cargo to the ground. The piston of the motor may move in a direction away from the latch, after the handle has been released, to move the latch pawl away from the latch.

Furthermore, in order to release the latch from the latch pawl, the cargo may be lifted slightly to clear the latch, allowing the latch to retract away from the latch pawl. The lowering of the cargo may continue until the cargo is in contact with the ground or until an internal switch causes the lowering of the cargo to stop or be cut out. This allows the cargo to be set down from the raised position to a lowered position so that the cargo can be drawn away from the cycle and moved to a desired location.

In some embodiments, each jack may separately be driven by its own lifting actuator, such as a motor. For example, a motor may be provided for each jack.

The motor may include a reduction gearbox. The reduction gearbox may reduce the motor speed by a factor of at least 50. The reduction may be a factor of 100 or 200, for example. For example, if the motor operates at a speed of around 8000 rpm, then the screw jack speed may be around 40 rpm.

One, some or all motors may include feedback means. The feedback means may be an encoder or any other suitable feedback means.

A processor may be provided for controlling each motor. The processor may be provided for controlling the speed of each motor. The processor may be considered as a central processor as it is used to control each motor. Where a processor is provided for controlling multiple jacks or motors, chains or other mechanical linkages between the motors may not be required.

Where feedback means is provided, the feedback means e.g., the or each encoder, may provide feedback to the processor. The processor may control the speed of one or all the motors based on the feedback. This allows the cargo to be raised and/or lowered whilst remaining substantially level. For example, this may be achieved by having the jacks or motors move at the same speed as each other.

A hinge stop bar may be provided on the U-shaped rear section of the cycle. The cargo may interact with the hinge stop bar. The cargo may interact with the hinge stop bar when the cargo is fully located within the U-shaped rear section of the cycle.

A docking switch may be provided. The docking switch may be disposed on the U-shaped rear section. The interaction between the hinge stop bar and the cargo may cause the docking switch to be actuated for supplying power to electrical components or circuit for example, supplying power to the motor. This may indicate that the cargo is fully located in the U-shaped rear section.

At least one securing means may be provided on the U-shaped rear section for preventing the cargo from slipping backwards along the movable side bars. The at least one securing means may be a cargo latch. The cargo latch may engage with the cargo when the cargo is fully located within the U-shaped rear section.

The cargo latch may be disposed on a or each movable side bar. The cargo latch may be disposed on an end of one or each movable side bar, the end of each movable side bar being disposed next to a respective second end of the side member of the U-shaped rear section.

The cargo latch may be released by an operator when retrieving the cargo from the cycle. The cargo latch may be mechanically operated such as a spring-loaded latch or remotely operated hydraulically, electrically, or using any suitable means e.g., at a different location on the cycle such as the handlebars or wirelessly (WI-FI) operated.

A lifting switch may be provided. The lifting switch may be actuated by an operator, for raising the cargo to the raised position. The lifting switch may be actuated when the cargo is fully secured to the U-shaped rear section i.e., through the use of the securing means. In otherwords, the lifting switch may be operated after the at least one securing means is fully engaged with the cargo. This ensures that the cargo is only lifted when the cargo has been properly secured to the U-shaped rear section.

The lifting switch may be actuated for lowering the cargo to the lowered position. This allows the operator to lower the cargo to the ground after transport to be moved away from the cycle towards a desired location.

The lifting switch may be a raising/lowering switch since it may be actuated to both raise and lower the cargo.

The lifting switch may be provided as a rocker switch. A first position of the rocker switch may lift or raise the cargo to the raised position, and a second position of the rocker switch may set down or lower the cargo to the lowered position. The rocker switch allows the operator to raise and lower of the cargo using one switch.

The lifting switch may be disposed next to the securing means. This allows for convenience since the operator can access both the lifting switch and the securing means easily.

The body of the motor may be engaged with a rod or a pin. The rod may actuate limit switches—an overload switch and a latch switch.

A shock absorber, for example, a plurality of washers such as Belville washers may be provided on the rod for eliminating shock loading of the motor when actuating the movement of the jacks to lift the movable side bars. The shock absorber may compress to a larger extent under heavier loads.

During lifting of the cargo, the overload switch may be actuated by the rod to stop the operation of the motor when a safe working load has been reached or exceeded. This prevents the motor from being damaged due to the excessive load applied to it. When the overload switch is actuated, the motor may allow the load to be lowered but not raised or lifted.

Any or all of the motors may be configured with a current limitation or other overload limitation. If the electrical current to the motor exceeds a predetermined threshold, the motor may not operate. Where provided, the processor may determine if the current threshold would be exceeded.

If the safe working load is not reached or exceeded during lifting of the cargo, once the engagement of the latch pawl and latch has been established, the motor may be reversed to remove the load from the motor and to secure the load on the latch by lowering the load onto the latch. Furthermore, the body of the motor may move towards the latch pawl causing the rod to actuate the latch switch. The actuation of the latch switch may cut the power of the motor. This prevents the motor from further lowering the load onto the latch thus, protecting the motor and the mechanism in general. This indicates that the cargo is transportable.

Braking means may be provided on the cycle. A brake disc and a brake calliper may be provided for each rear wheel. Each brake calliper may be actuated by pushing onto or contacting with its respective brake disc. The brake callipers may be actuated mechanically, electrically, hydraulically or any suitable means. The braking force applied by the braking means must be applied equally to prevent swerving of the cycle.

The location of the at least one rear wheel along each side member may vary depending on the length and weight distribution of the load within the cargo.

The at least one rear wheel on each side member of the U-shaped rear section may be disposed substantially at the centre or slightly offset from the centre of the length of the side member towards the second end of side member. This allows the cargo to be positioned and carried between the rear wheels. Since most of the weight of the cargo is supported by the rear wheels, the front section of the cycle only needs the strength to carry transmission and the weight of a rider. This also allows the cycle to be compact and have good balance. Furthermore, it allows the cycle to be made from lighter materials.

Two rear wheels may be provided on each side member of the U-shaped rear section. This helps the cycle to carry heavier loads and allows the cycle to easily be manoeuvred in soft ground. Furthermore, this allows the cycle to be adapted for track laying which is advantageous in snow and ice regions for example, for deliveries in a ski resort. Where two rear wheels are utilised on each side member, they may be coaxial or sequential.

According to the second aspect of the present invention, there is provided a cargo pod for use with a cycle according to the first aspect of the present invention for carrying cargo.

The cargo pod may be a container designed to carry humans, animals, and organic and inorganic materials. The cargo pod may come in different shapes and/or forms to allow different materials to be carried. Furthermore, the shape of the cargo pod may be customised to suit a specific use.

The cargo pod may comprise a base, a first wall provided as a front wall, a second wall provided as a first side wall, and third wall provided as a second side wall.

A plurality of wheels may be provided on the cargo pod. The wheels may be disposed on a base of the cargo pod. The wheels may be castor wheels, or similar. This allows the cargo pod to easily be positioned or aligned within the U-shaped rear section of the cycle by wheeling. This also allows the cargo pod to be easily moved towards or away from the U-shaped rear section without needing to lift the cargo pod in and out of position. This means that additional lifting means is not required to position the cargo pod. In addition, people do not need to manually carry the cargo pod which can prevent injury.

Preferably, four wheels are provided on the base of the cargo pod, each wheel being disposed on each corner of the base of the cargo pod. This allows the cargo pod to be supported and wheeled by the wheels evenly.

When the cargo pod is securely engaged with the U-shaped rear section of the cycle, the cargo pod may move with the movement of the movable side bars of the cycle i.e., raised or lowered. This allows the cargo pod to move in a direction away from the ground when lifting, or towards the ground when setting down the cargo pod.

The centre of mass of the cargo pod may be arranged to be just forward of the centre line of the rear wheels of the cycle. This allows the front wheel of the cycle to be kept on the ground preventing the cycle from lifting from the ground due to the weight applied to the U-shaped rear section of the cycle. This provides the arrangement of the cycle and cargo pod with good balance.

The cargo pod may further comprise a fourth wall provided as a rear wall. The rear wall of the cargo pod may be provided as a door or doors. The door(s) may be lockable door(s) in that locking means may be provided on the door(s).

Note that the cargo pod may come in different shapes or forms to allow the cargo pod to carry different types of load or cargo. The walls of the cargo pod may form a container allowing the cargo pod to carry load or cargo.

The cargo pod may include a lid. The lid may be hinged to an upper edge of the front wall. This allows the cargo pod to be opened from the rear of the cycle therefore, the cargo pod does not need to be detached from the cycle first before loading and unloading cargo.

Alternatively, the lid may be hinged to another wall of the cargo pod or connected to the cargo pod in another way.

The cargo pod may include a footwell. When the cargo pod only comprises, the base, and the first, second and third walls, the footwell may be disposed on the rear of the cargo pod. This allows the cargo pod to be adapted to carry cargo such as long materials e.g., long tubes or a wheelchair, for example.

A front rail may be attached to the front wall of the cargo pod. A side rail may be attached to each side wall of the cargo pod. A rear rail may be attached to the rear wall of the cargo pod.

In use, each side rail of the cargo pod may overlie a respective movable side bar of the cycle. This allows the cargo pod to be lifted as the movable side bars move upwardly from the side members of the U-shaped rear section of the cycle and allows the cargo pod to be set down as the side bars move downwardly towards the side members of the U-shaped rear section.

An end of each side rail may be curved upwardly. This allows the side rail to facilitate the engagement of the cargo pod with the movable side bars of the cycle. Each side rail may be chamfered. The chamfer may be located on an end of the side rail disposed next to the front wall. The chamfer on the side rails may compliment the chamfer on the movable side bars of the cycle. Advantageously, this helps guide the vertical approach of the cargo pod towards the U-shaped rear section of the cycle. On flat level ground, there may be a clearance between the underside of the side rails and the upper surface of the movable side bars of the cycle to facilitate unimpeded positioning of the cargo pod and any load within.

The front wall of the cargo pod may interact with the hinge stop bar on the U-shaped rear section of the cycle when the cargo pod is fully located within the U-shaped rear section of the cycle. The interaction may cause the docking switch to be actuated for supplying power to electrical components or circuit for example, supplying power to the motor.

A stop member may be provided on a or each side wall of the cargo pod. This allows the cargo pod to be placed and maintained in the desired position in the U-shaped rear section of the cycle. Furthermore, the at least one securing means such as the cargo pod latch on a or each movable side bar of the U-shaped rear section of the cycle may hold or lock a respective stop member of the cargo pod in place. This allows the cargo pod to be secured into place with respect to the U-shaped rear section of the cycle thereby, preventing the cargo pod from sliding away from the U-shaped rear section or prevents the cargo pod from being stolen.

When the cargo pod is fully secured to the U-shaped rear section, the front rail and stop member may be trapped beneath the movable side bars of the cycle and the head member connecting the movable side bars to each other. This stops the cargo pod lifting off from the cycle over bumps on the road or ground and prevents theft of the cargo pod as well.

A handle may be attached to the rear wall of the cargo pod. This enables the cargo pod to be manoeuvred easily by an operator to a desired position or location.

According to a third aspect of the present invention, there is provided a cycle for carrying cargo comprising:
a cycle frame having a front section mounting a steerable front wheel and a U-shaped rear section having a head member and side members, with at least one rear wheel being mounted to each side member,
a space disposed between the side members and rear wheels, and
lifting means provided along the side members for engaging with and lifting a cargo pod positioned in the space.

The third aspect of the present invention may include features of the first aspect of the invention.

The third aspect of the invention may be used with the second aspect of the present invention.

### BRIEF DESCRIPTION OF THE DRAWINGS

For a better understanding of the present invention, and to show more clearly how it may be carried into effect, reference will now be made by way of example only to the accompanying drawings, in which:

FIG. 1A shows a plan view from above of a cycle for carrying cargo, according to the first aspect of the present invention;

FIG. 1B shows a side view of the cycle of FIG. 1A;

FIG. 2 shows a perspective view of the cargo pod carried by the cycle, according to the second aspect of the present invention;

FIG. 3 shows an exploded perspective view of part of the cycle of FIG. 1A;

FIG. 4A shows a side view of the cycle and cargo pod of FIGS. 1A and 2 prior to loading the cargo pod with a rear wheel removed to reveal the lifting mechanism;

FIG. 4B shows a side view of the cargo pod being engaged on the cycle;

FIG. 4C shows a side view of the cargo pod engaged and lifted on the cycle;

FIG. 5 shows a perspective view of short and long wheelbase cycles;

FIG. 6 shows a perspective view of a lifting actuator used to raise and lower the cargo pod;

FIGS. 7A to 7E show side views of the lifting actuator of FIG. 6 in different stages of actuation and locking;

FIG. 8 shows a perspective view of the drivetrain of the cycle of FIG. 1A;

FIG. 9A shows a side view of cargo pod being engaged with the movable side bars and head member of the cycle;

FIG. 9B shows a side view of the cargo pod engaged with the movable side bars and head member of the cycle;

FIG. 10A shows perspective view of another embodiment of the cycle and another embodiment of the cargo pod;

FIG. 10B shows a perspective view of the cargo pod of FIG. 10A engaged on the cycle of FIG. 10A;

FIG. 11 shows a side view of the cargo pod of FIGS. 10A and 10B engaged and lifted on the cycle;

FIG. 12A shows a perspective view of the cycle of FIGS. 10A and 10B and a pallet and a forklift;

FIG. 12B shows a perspective view of the pallet in FIG. 12A lifted by the forklift on the cycle;

FIG. 13 shows a perspective view of the pallet of FIGS. 12A and 12B engaged and lifted on the cycle;

FIG. 14A to 14C show perspective views of the different configurations of the cycle for engaging the pallet on the cycle;

FIG. 15A shows a perspective view of the cycle of FIGS. 10A to 14 and a cage;

FIG. 15B shows a perspective view of the cage engaged on the cycle;

FIG. 16 shows a perspective view of the cage engaged and lifted on the cycle;

FIG. 17 shows a perspective view of a supporting surface of the cycle of FIGS. 10A to 16 with a platform disposed in a stowed position;

FIG. 18 shows a perspective view of U-shaped rear section of the cycle of FIGS. 10A to 16 with a longer supporting surface; and

FIG. 19 shows a perspective view of the U-shaped rear section of the cycle of FIGS. 10A to 16 with a housing for covering powered lifting means.

### DESCRIPTION OF PREFERRED EMBODIMENTS

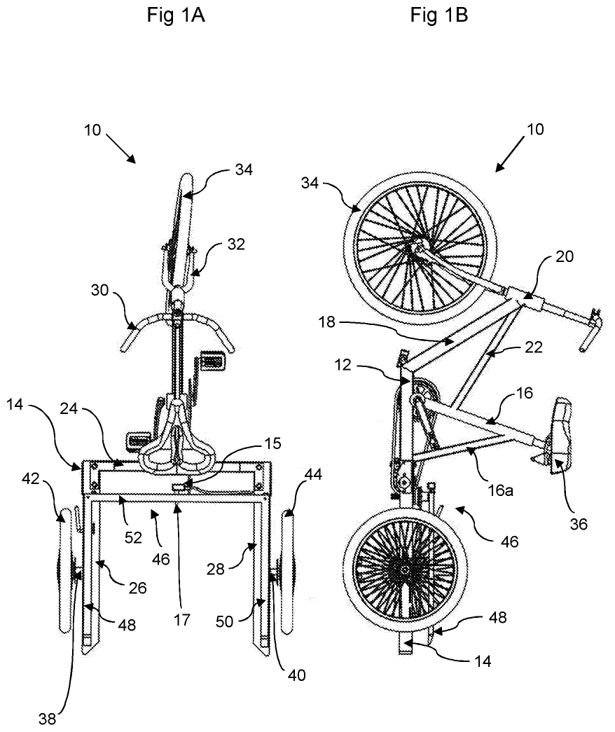

Referring firstly to FIGS. 1A and 1B, a cycle for carrying cargo is indicated generally at 10. The cycle 10 has a frame including a central spar 12, a U-shaped rear section 14, a seat tube 16 and brace member 16a, a downtube 18, a headtube 20, and a crossbar 22, sometimes referred to as a top tube. The downtube 18 connects the headtube 20 to the central spar 12 and the crossbar 22 connects onto the seat tube 16. The U-shaped rear section 14 includes a head member 24 and two side members 26, 28. The central spar 12 is connected centrally to the head member 24.

Handlebars 30 are mounted through the headtube 20 in conventional manner and connect to front forks 32 supporting a front wheel 34. A seat 36 is mounted in conventional manner to the seat tube 16 and is height adjustable. The forward part of the frame in front of the U-shaped rear section 14 carries the transmission, described further below, and supports the weight of a rider in a conventional way. Advantageously, the forward part of the frame can therefore be of a substantially usual weight. It can also be manufactured with the compactness and balance of a frame associated with a 2-wheeled cycle.

Axles 38, 40 are mounted to the underside of the side members 26, 28. The axles mount wheels 42, 44. A powered lifting means, indicated generally at 46, is mounted to the U-shaped rear section 14. The powered lifting means 46 includes movable side bars or trammel bars 48, 50, which lie substantially above the side members 26, 28 of the U-shaped rear section 14. The side bars 48, 50 are driven up and down by a plurality of jacks, described further below. The side bars 48, 50 are connected by a head member 52, which extends between the side bars 48, 50, but behind the position of the head member 24 of the U-shaped rear section 14. The side bars 48, 50 and head member 52 also form a U-shaped frame, a lifting frame.

The wheels 42, 44 are mounted substantially at the mid-point or slightly offset from the mid-point towards the rear of the side bars 48, 50, such that they support the majority of any weight in a cargo pod, which may be positioned on the lifting frame.

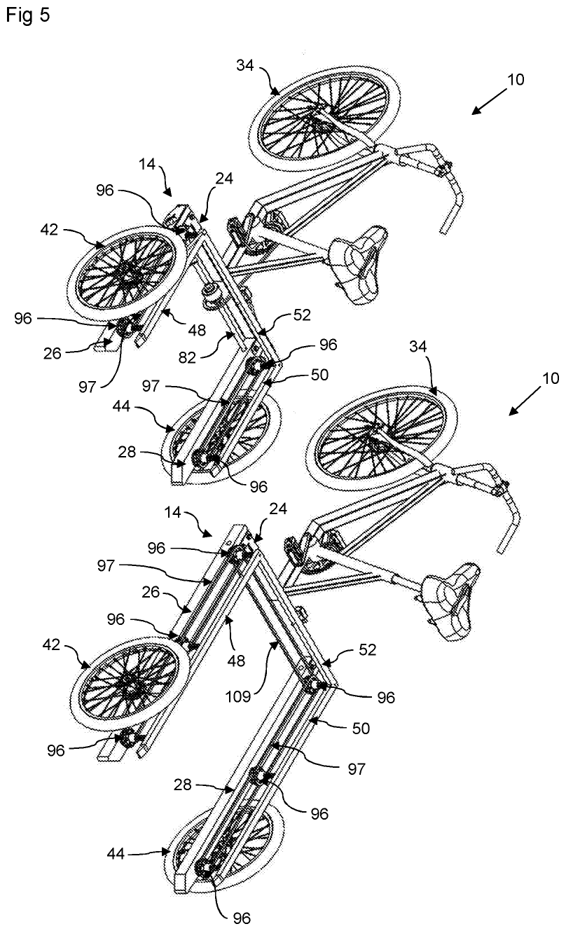

Alternatively, the wheels 42, 44 can be mounted substantially at the rear of the side bars 48, 50, as shown in FIG. 5. The location of the wheels 42, 44 can vary depending on the length and weight distribution of the load within the cargo pod 54.

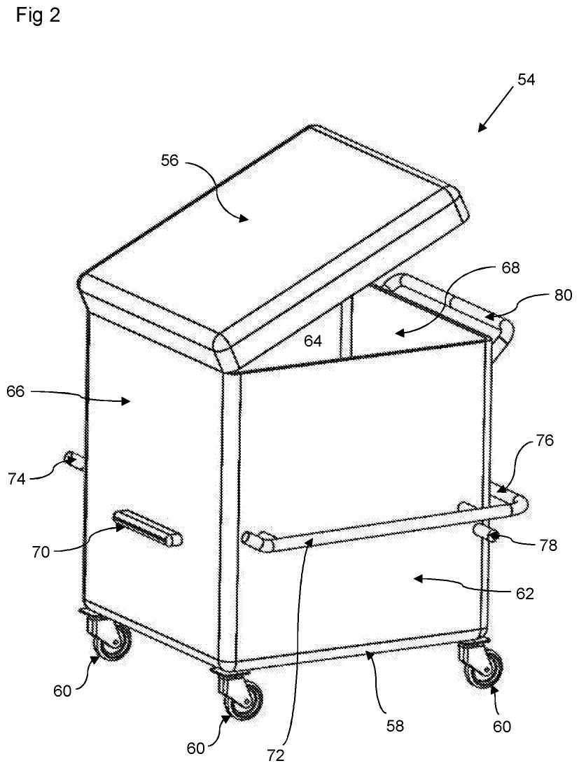

Referring also to FIG. 2, a cargo pod for use with the cycle 10 is indicated generally at 54. The cargo pod 54 is a substantially rectangular wheeled container with a lid 56. It has a rectangular base 58 supported on four castors 60, positioned at the corners of the base 58. There are two side walls 62, 64, a front wall 66 and a rear wall 68 extending upwardly from the base 58 to form the container. The lid 56 is hinged to the upper edge of the front wall 66 but could be hinged to another wall or connected in another way. By hinging the lid 56 from the front wall 66, it is easy to access the inside of the cargo pod 54, from the rear of the cycle, when it is located on the cycle 10.

The cargo pod 54 can come in different shapes and forms for example, the cargo pod 54 may only comprise of a base 58, a front wall 66 and two side walls 62, 64. This allows the cargo pod 54 to be able to carry different types of cargo such as long materials, plants or a wheelchair, for example.

A front rail 70 is attached to the front wall 66 and extends horizontally across at least a part of its width. Side rails 72, 74 are mounted to respective side walls 62, 64 and extend horizontally from the front wall 66 to the rear wall 68. In this embodiment, the side rails 72, 74 extend around the rear wall 68 and are connected together by a rear rail 76.

A stop member 78 is provided on each side wall 62, 64 below the side rails 72, 74 proximate the rear wall 68. A handle 80 is attached to the rear wall 68 and enables the cargo pod 54 to be manoeuvred by hand to a desired position. It will be noted that the front ends of the side rails 72, 74 are cranked upwardly to facilitate engagement with the cycle 10 as described further below.

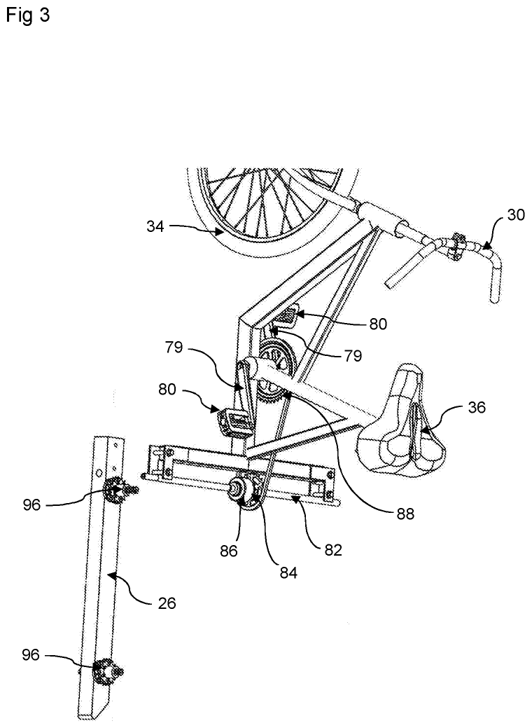

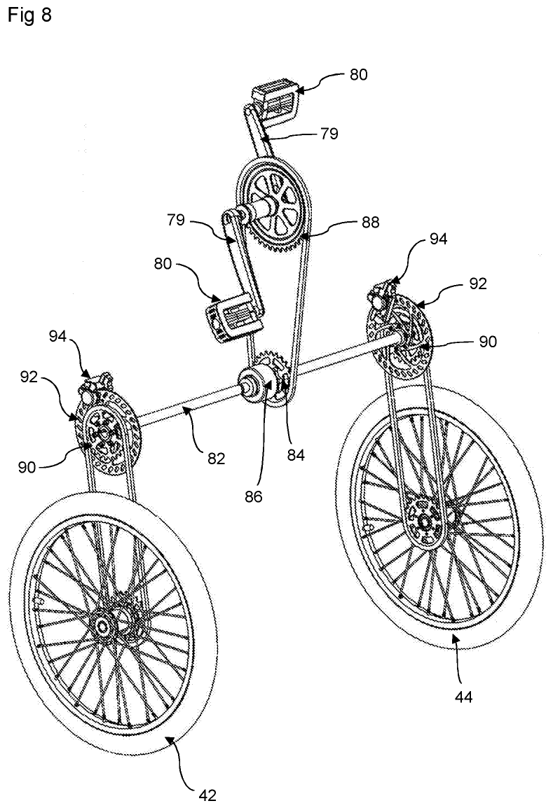

Referring now to FIGS. 3 and 8, the cycle 10 can be driven by a conventional pedal drive including at least one chain ring 88 driven by left and right cranks 79 and pedals 80. A drive shaft, preferably a differential axle 82 is rotationally mounted in the U-shaped rear section 14. A drive sprocket 84 driving a differential hub 86 is mounted substantially centrally on the differential axle 82 and is connected to the pedal drive by the chain ring 88. The pedals 80 can drive a geared hub (not shown) situated midway between the pedal cranks 79 and the drive sprocket 84, whilst a frame mounted motor (not shown) can drive a further sprocket arranged to be coaxially adjacent and attached to the drive sprocket 84. Similar to the geared hub, the frame mounted motor can directly drive the differential hub 86 which in turn drive the differential axle 82.

Chain rings 90 are provided on the ends of the differential axle 82 which drive the rear wheels 42, 44 through chains and sprockets. Braking discs 92 are provided on each of the chain rings 90, which are braked by brake callipers 94. The callipers 94 can be actuated mechanically, electrically or hydraulically. The braking force must be applied equally to prevent swerving of the cycle 10. Callipers 94 actuated hydraulically can achieve this with a single brake lever (not shown) pressurising a hydraulic line with branches to both callipers 94 such that the callipers 94 are subject to equal pressure.

The side bars 48, 50 are moved up and down by a plurality of jacks 96. In the embodiment shown in FIG. 5, there are four jacks 96, two for lifting the front and rear of each side bar 48, 50. In another embodiment shown in FIG. 5, there are six jacks 96, two for lifting the front, centre and rear of each side bar 48, 50. The jacks 96 are linked together so that they move up and down in unison. The jacks on each side member 26, 28 are linked together by means of a chain drive 97, which drives a screw through a sprocket on each jack 96. However, it will be appreciated that the jacks 96 could be driven hydraulically or electrically or using other mechanical means such as a drive shaft or similar. It is important that they operate together, in order to raise the cargo pod 54 evenly.

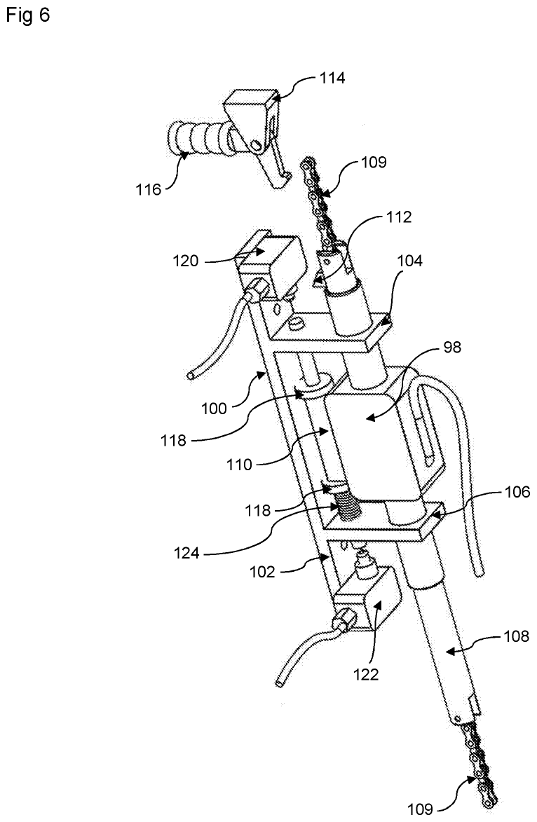

In the current embodiment, as shown in FIG. 6, the jacks 96 are driven by a linear electric motor 98. The motor 98 is mounted in a cradle 100 comprising a base plate 102 and spaced vertical flanges 104, 106. The motor 98 is supported within the cradle 100, such that it can move from side to side to a limited extent. A piston 108 of the motor 98 is driven in a direction to one side or other of the cradle 100 dependent on whether the side bars 48, 50 are being raised or lowered. The piston ends of the motor 98 are connected to ends of a chain 109 which connect with the jacks 96 on either side of the cycle 10.

Latching means is provided on the U-shaped rear section 14. The latching means comprises a latch pawl 112 and a latch 114. The latch pawl 112 is mounted to the left-hand end of the piston 108, as viewed in FIG. 6. The latch pawl 112 engages with the latch 114, when the piston 108 is almost fully moved to the left (as viewed). This corresponds to the jacks 96 being in a fully raised position. The latch 114 and latch pawl 112 serve as a locking means for holding the jacks 96 and the cargo pod 54 in a raised position during transit of a cargo pod 54. This takes the load off the motor 98.

The latch 114 has a handle 116, enabling its release for lowering of the load. The cargo pod 54 is lifted slightly to clear the latch 114 allowing the latch 114 to retract away from the latch pawl 112. The piston 108 of the motor 98 moves in a direction away from the latch 114 after the handle 116 has been released to move the latch pawl 112 away from the latch 114. The lowering of the cargo pod 54 continues until the cargo pod 54 is in contact with the ground, or an internal switch (not shown) causes the lowering of the cargo pod 54 to be cut out.

A rod 110 extends beneath the motor 98 and passes through apertures in the flanges 104, 106. The body of the motor 98 is engaged with the rod 110 by retaining flanges 118 on the rod 110. In other words, any lateral movement of the motor 98 between the flanges 104, 106 is connected to the lateral movement of the rod 110. They move together.

A latch switch 120 and an overload switch 122 are disposed outside the left and right flanges respectively, as viewed in FIG. 6. The rod 110 extends through the flanges and at the extremities of its movement, contacts and actuates the switches 120, 122 as described further below. A shock absorber namely a plurality of spring washers 124, for example, Belville washers, are mounted about the rod 110, between the position of the motor 98 and the right-hand flange 106 (as viewed). The washers 124 substantially eliminate shock loading of the motor gearing during lifting of the side bars 48, 50. They also compress to a larger extent under heavier loads, and when a safe working load is exceeded, the overload switch 122 is operated.

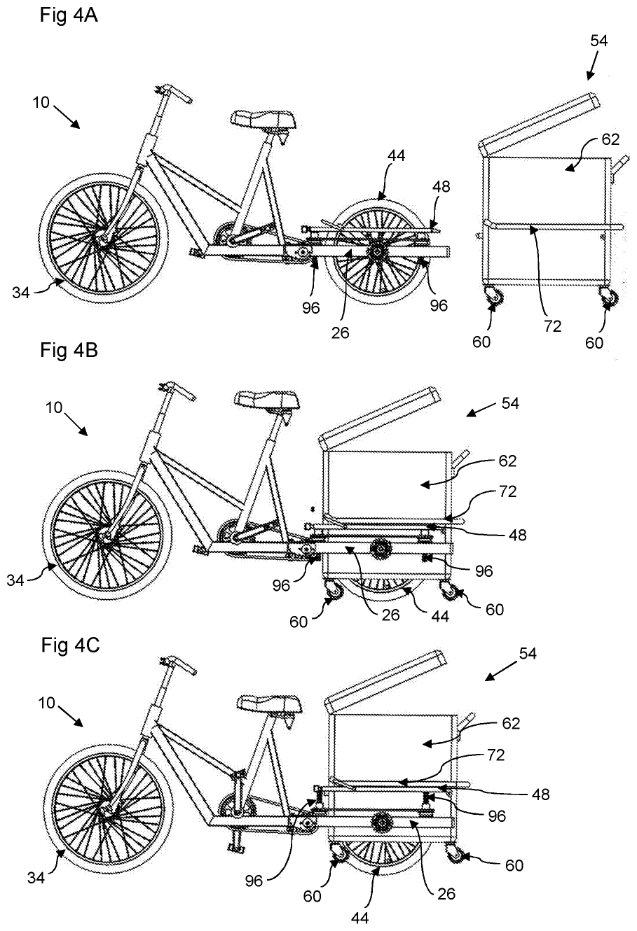

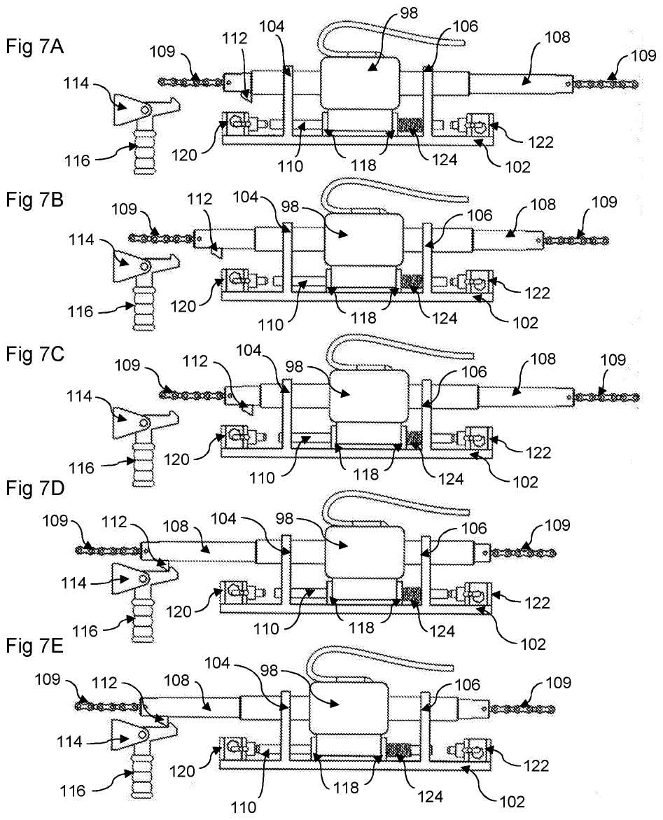

The operation of the cycle 10 will now be described with reference in particular to FIGS. 4A to 4C and 7A to 7E. In FIG. 4A, the cargo pod 54 is positioned at the rear of the cycle 10 and the side bars 48, 50 are disposed in a lowered position, ready to receive the cargo pod 54. The piston 108 of the motor 98 is fully extended to the right-hand side of the motor 98, as viewed in FIG. 7A. The rod 110 is positioned substantially centrally of the flanges 104, 106.

The cargo pod 54 can then be pushed into the U-shaped rear section 14 of the cycle 10, until the side rails 72, 74 overlie respective side bars 48, 50, as shown in FIG. 4B. The ends of the side members 26, 28 are chamfered at an angle. This presents a “birdmouth” entrance towards the rear of the cycle 10, which assists in guiding the cargo pod 54 between the side members 26, 28. In addition, the side bars 48, 50 have a chamfered leading edge to compliment the chamfer on the side rails 72, 74. The chamfered side members 26, 28 centralise the horizontal approach of the cargo pod 54 whilst the chamfered side rail 72, 74 of the cargo pod and the chamfered side bars 48, 50 centralise the vertical approach of the cargo pod 54.

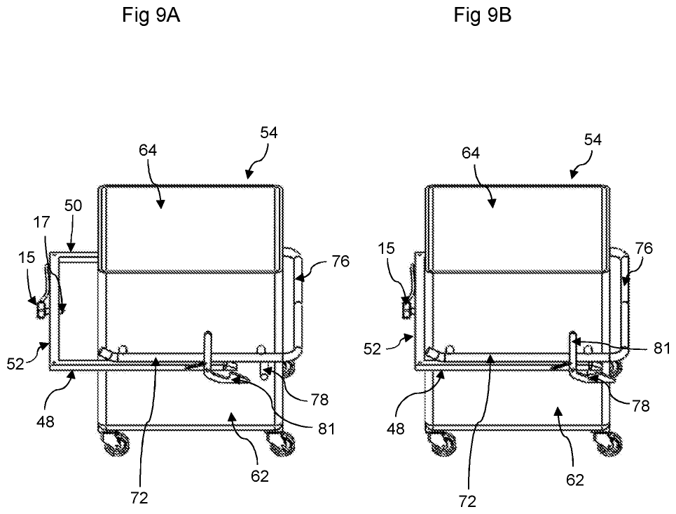

A securing means such as a cargo pod latch 81 as shown in FIG. 9A can be provided on the rear of each movable side bar 48, 50 for securing or locking the cargo pod 54 to the U-shaped rear section 14. On flat level ground, there is clearance between the underside of the side rails 72, 74 and the upper surface of the side bars 48, 50, to facilitate unimpeded positioning of the cargo pod 54 and any load within.

Referring to FIG. 7B, when the cargo pod 54 has been pushed into the U-shaped rear section 14 of the cycle 10, the front wall 66 of the cargo pod 54 interacts with a hinge stop bar 17, shown in FIGS. 1A and 9A, on the head member 52 of the U-shaped rear section 14. The interaction causes a docking switch 15, shown in FIGS. 1A and 9A, to be actuated for supplying power to electrical components or circuit for example, supplying power to the motor 98, once the cargo pod is fully located within the U-shaped rear section 14.

The claw of the cargo pod latch 81 locks or holds the stop member 78 in place as shown in FIG. 9B thereby, preventing the cargo pod 54 from sliding away from the U-shaped rear section and also prevents the cargo pod 54 from being stolen. The cargo pod latch 81 can be manually released when retrieving the cargo pod 54 from the cycle 10.

The cargo pod latch 81 can be mechanically operated such as a spring-loaded latch or remotely operated hydraulically, electrically, or using any suitable means e.g., at a different location on the cycle 10 such as the handlebars 30 or wirelessly (WI-FI) operated.

A lifting switch (not shown) is operated for raising the cargo pod 54 to a raised position through movement of the jacks 96 as shown in FIG. 4C. The lifting switch is also operated for lowering the cargo pod 54 to a lowered position for example, after transport. The lifting switch can be a rocker switch. A first position of the rocker switch lifts the cargo pod 54 to the raised position and a second position of the rocker switch sets down the cargo pod 54 to the lowered position.

To lift the cargo pod 54 in the raised position, the piston 108 of the motor 98 is moved towards the flange 104 or the left-hand side of the motor 98. In this figure, the piston 108 is somewhat extended equally on either side of the motor 98. At the same time, the rod 110 moves towards the direction of the flange 106, closer to the overload switch 122. The washers 124 are compressed between the retaining flange 118 and the flange 106 due to the reduced distance between the retaining flange 118 and the flange 106.

Referring to FIG. 7C, the washers 124 are specified to compress by a known amount, when a given amount of load is applied to them. Thus, when the cargo pod 54 load reaches or exceeds the safe working load, the rod 110 moves towards the direction of the flange 106 further. The washers 124 are compressed by a set length due to the movement of the rod 110. The right-hand end of the rod 110 presses on the overload switch 122 thereby operating it. The overload switch 122 interrupts the power supply to the motor 98. The motor 98 is reversed allowing the piston 108 to reverse and move back to the right-hand side of the motor 98. Effectively, when the overload switch 122 is operated, the motor 98 allows the cargo to be lowered but not lifted.

Referring to FIG. 7D, when the load does not reach or exceed the safe working load, the piston 108 is fully moved to the left-hand side of the motor 98. The latch pawl 112 mounted to the left-hand end of the piston 108, engages with the claws of the latch 114. The handle 116 of the latch 114 first moves slowly to an open position before snapping to a closed position as the latch pawl 112 engages with the claws of the latch 114. The right-hand end of the rod 110 moves slightly to a position towards to the overload switch 122.

Referring to FIG. 7E, once the engagement between the latch pawl 112 and the latch 114 is established, the load is removed from the motor 98 by reversing the motor 98 causing the load to be secured to the latch 114. This causes the motor 98 to contract thereby, rendering the latch pawl 112 to be immovable by the latch 114. The body of the motor 98 moves towards the latch pawl 112 causing the rod 110 to actuate the latch switch 120. The actuation of the latch switch 120 causes power of the motor 98 to be withdrawn after the motor 98 has lowered the load from fully raised position onto the latch 114 so that the load cannot be lowered further and the latch 114 can support the load. The transfer of the load from the motor 98 to the latch 114 means that there is no load on the motor 98. This protects the motor 98 and the mechanism in general. This corresponds to the jacks 96 being in a raised position, as shown in FIG. 4C, and the cargo pod is in a transportable state. The distance between the retaining flange 118 and the flange 106 increases forming a gap between the washers 124 and the flange 106.

When the cargo pod 54 is fully secured to the U-shaped rear section 14, the front rail 70 and stop member 78 are trapped beneath the side members 48, 50 and the head member 52. This stops the cargo pod 54 lifting off from the side bars 48, 50 over bumps on the road or ground and prevents theft of the cargo pod 54.

To lower the cargo pod 54 from the raised position, the latch 114 is manually operated by releasing its handle 116 for lowering the load. In order to release the latch 114, the cargo pod 54 must be slightly lifted to clear the latch 114. The latch 114 retracts and the load is lowered. The load will be lower until the cargo pod 54 is in contact with the ground or until an internal switch (not shown) cuts out the lowering of the load. The cargo pod 54 can then be drawn away from the U-shaped rear section 14 of the cycle 10.

The majority of the weight of the cargo pod 54 positioned on the lifting frame is supported by the rear wheels 42, 44 of the cycle 10. Therefore, the front section of the cycle 10 only needs the strength to carry transmission and the weight of a rider. Furthermore, the powered lifting means 46 of the cycle 10 is positioned close to the rear wheels 42, 44 at a relatively low position. This makes for good distribution of the load and improves the balance of the cycle 10. This also allows the cycle 10 to be compact and to be made from lighter materials since the cycle 10 does not need to support the weight of the cargo pod 54 or the load from a high and unstable position relative to the axle height of the rear wheels 42, 44.

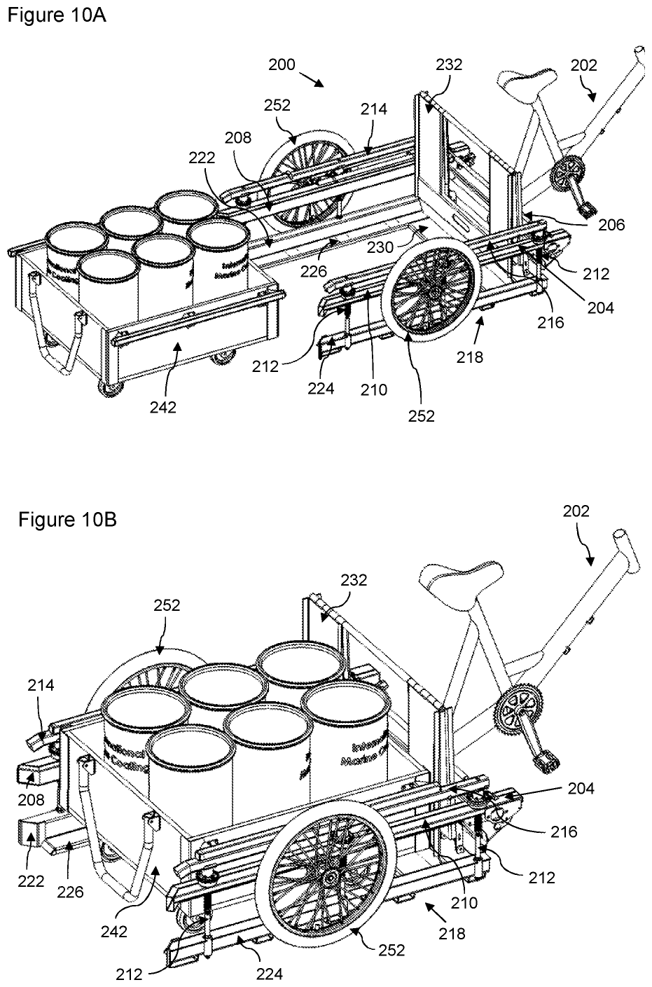

Referring to FIGS. 10A to 19, a further embodiment of the cycle for carrying cargo is indicated generally at 200. The cycle 200 comprises a cycle frame including a front section 202 and a U-shaped rear section 204. The U-shaped rear section 204 includes a head member 206 and two side members 208, 210. Rear ends of the side members 208, 210 are chamfered at an angle. This presents a “birdmouth” entrance towards the rear of the cycle 200, which assists in guiding a cargo within a space provided between the side members 208, 210 of the U-shaped rear section 204.

A powered lifting means, indicated generally at 212, is mounted to the U-shaped rear section 204. The powered lifting means 212 are disposed along the side members 208, 210 of the U-shaped rear section 204. The powered lifting means 212 is similar to the lifting means shown in FIGS. 1 to 9B in that, in this embodiment, the powered lifting means 212 is a plurality of jacks 212 connected to each other by chains connected to a motor for actuating the movement of the jacks 212. In FIGS. 10A to 19, however, the jacks 212 have a longer length than those shown in FIGS. 1 to 9B.

The powered lifting means 212 includes a movable lifting apparatus. The movable lifting apparatus includes a pair of movable side bars 214, 216 or trammel bars which substantially lie above the side members 208, 210 of the U-shaped rear section 204. The movable lifting apparatus also includes a supporting surface 218 which substantially lie below the side members 208, 210 of the U-shaped rear section 204. In other embodiments, the movable lifting apparatus may only include a pair of movable side bars 214, 216 or a supporting surface 218.

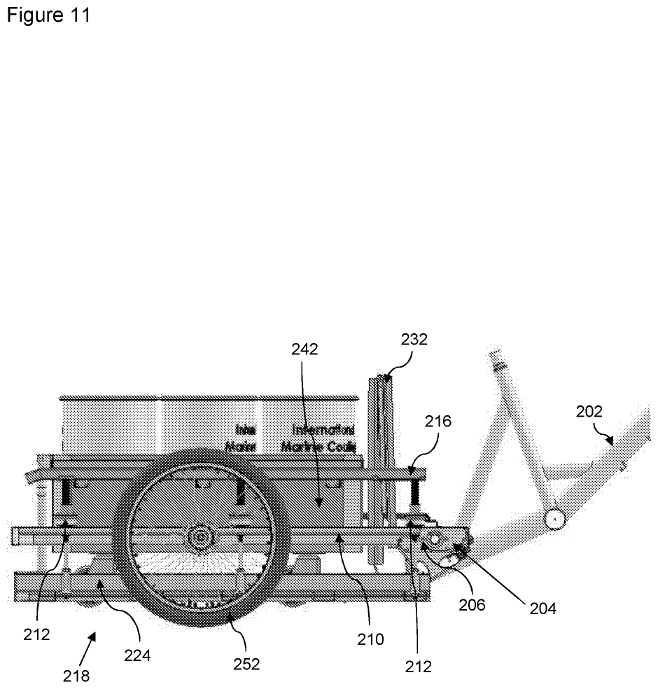

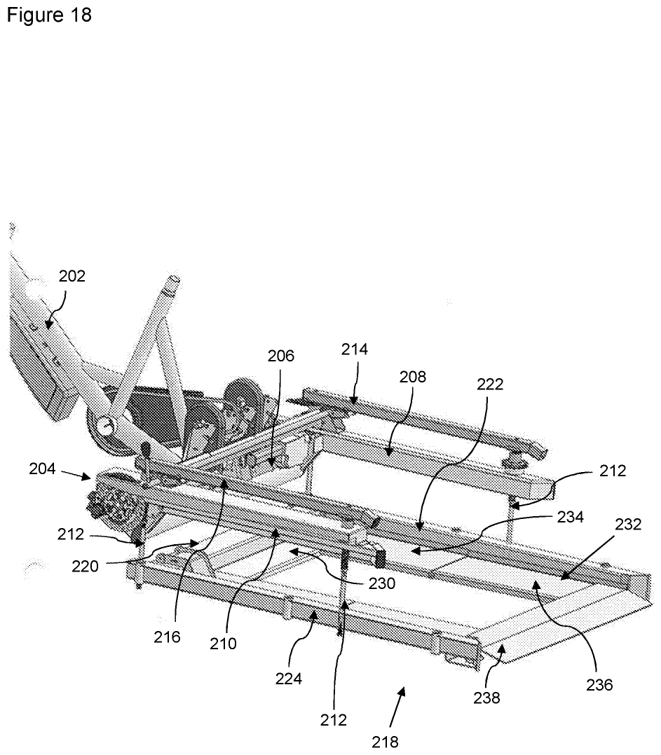

A rear end of each side bar 214, 216 is chamfered downwardly at an angle from front to rear. This is shown more clearly in FIG. 18. Each chamfered end of the side bars 214, 216 is disposed next to a respective chamfered end of the side members 208, 210 of the U-shaped rear section 204. The chamfered ends of the side bars 214, 216 of the movable lifting apparatus help guide the vertical approach of the cargo towards the U-shaped rear section 204 for example, a cargo pod as shown in FIGS. 10A to 11.

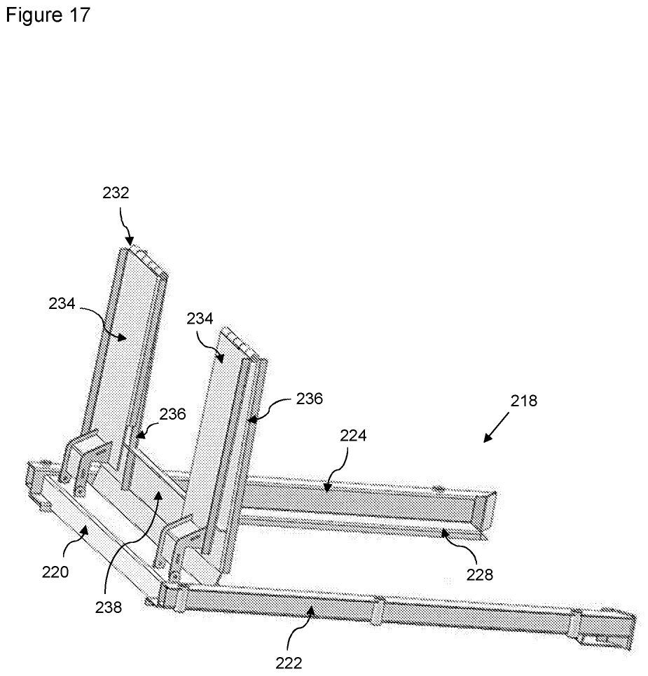

The supporting surface 218 of the movable lifting apparatus is shown in more detail in FIG. 17. The supporting surface 218 comprises a lower U-shaped frame having a head member 220 and side members 222, 224. Side supporting elements 226, 228 are connected to respective side members 222, 224 of the lower U-shaped frame.

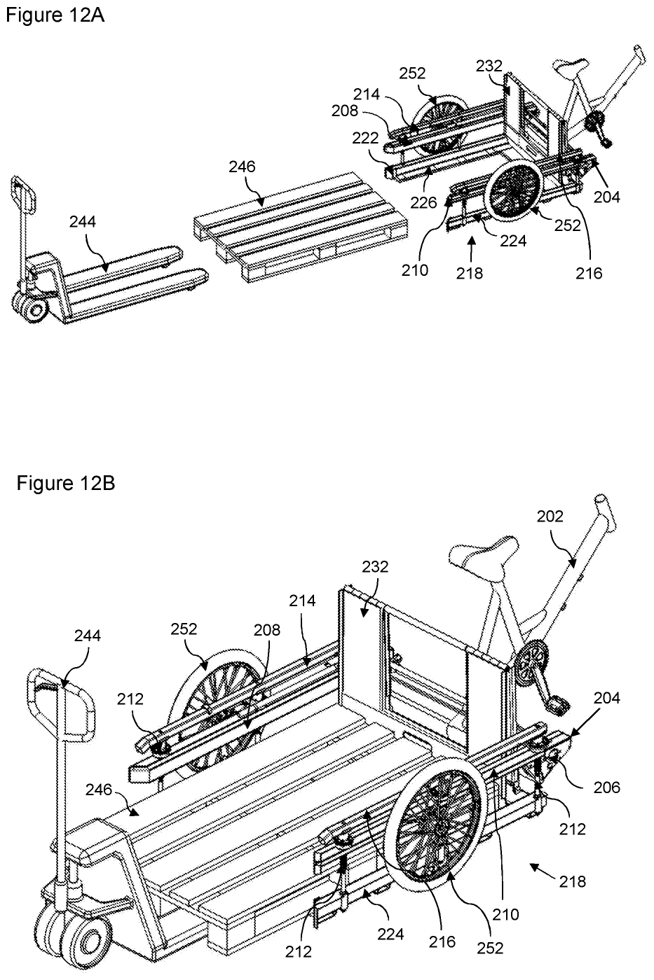

The ends of the side members 222, 224 of the lower U-shaped frame are chamfered at an angle. This also presents a “birdmouth” entrance towards the rear of the cycle 200, which assist in guiding the horizontal approach of the cargo on the cycle 200, for example a pallet as shown in FIGS. 12A to 14.

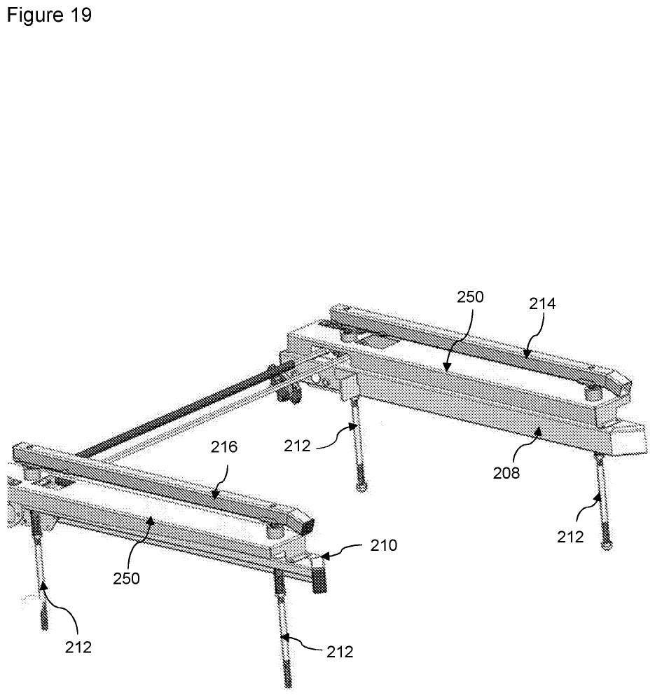

In FIGS. 10A to 16, three jacks 212 are mounted on each side member 208, 210 of the U-shaped rear section 204 and are equally spaced apart from each other. In FIGS. 18 and 19, two jacks 212 are mounted on each side member 208, 210 of the U-shaped rear section 204. A first jack is disposed at a front end of each side member 208, 210 and a second jack is disposed at a rear end of each side member 208, 210. Each jack 212 on a side member 208, 210 of the U-shaped rear section 204 is aligned with a respective jack 212 on the other side member 208, 210. This allows the jacks 212 to be able to support the cargo loaded on the cycle 200 evenly.

A first end of a screw threaded rod of each jack 212 is connected to a side bar 214, 216 of the movable lifting apparatus and a second end of the rod of each jack 212 is connected to a side member 222, 224 of the lower U-shaped frame of the supporting surface 218. This allows the powered lifting means 212 to move the movable lifting apparatus upwardly and downwardly with respect to the U-shaped rear section 204 of the cycle 200. It also allows the side bars 214, 216 and the supporting surface 218 to move in unison with each other.

A side supporting element 226, 228 is connected to a lower end of each side member 222, 224 of the lower U-shaped frame. This means that when the cycle 200 is in a lowered position, the bottom surface of the side supporting elements 226, 228 may contact the ground. A length of each side supporting element 226, 228 extends in a direction parallel to a length of the side members 222, 224 of the lower U-shaped frame. In other words, a side supporting element 226, 228 extends from a front end to the rear end of each side member 222, 224 of the lower U-shaped frame of the supporting surface 218. A rear end of the side supporting elements 226, 228 terminate before the chamfered ends of the side members 222, 224 of the lower U-shaped frame.

A width of each side supporting element 226, 228 extends from a side member 222, 224 of the lower U-shaped frame in a direction towards the other side member 222, 224. The side supporting elements 226, 228 are spaced apart by a predetermined distance from each other. In other words, a space is provided between the side supporting elements 226, 228.

In this embodiment, the side supporting elements 226, 228 are fixed to the side members 222, 224 of the lower U-shaped frame. Each side supporting element 226, 228 is welded to a respective side member 222, 224 of the lower U-shaped frame.

A rear end of each side supporting elements 226, 228 is chamfered downwardly at an angle or tapered from front to rear thereby forming a side ramp. This enables the cargo to be pushed or wheeled more easily on the side supporting elements 226, 228 and thus, the cycle 200.

A front supporting element 230 is connected to a lower end of the head member 220 of the lower U-shaped frame of the supporting surface 218. The front supporting element 230 is disposed between front ends of the side supporting elements 226, 228. A length of the front supporting element 230 extends in a direction parallel to a length of the head member 220 of the lower U-shaped frame. The front supporting element 230 is disposed substantially centrally along the length of the head member 220 of the lower U-shaped frame. A width of the front supporting element 230 extends from the head member 220 in a direction towards a central portion of the side supporting elements 226, 228. An upper surface of the front supporting element 230 lies flush with the upper surfaces of the side supporting elements 226, 228. This allows the cargo to be supported evenly on the supporting elements 226, 228, 230 of the cycle 200. It also allows the front supporting element 230 to provides further support to a front of the cargo.

In this embodiment, the front supporting element 230 is fixed to the head member 220 of the lower U-shaped frame. The front supporting element 230 is welded to the head member 220 of the lower U-shaped frame. The side supporting elements 226, 228 and the front supporting element 230 are welded on the lower U-shaped frame to form a single unit.

The supporting surface 218 includes a platform 232. The platform 232 enables cargos that cannot be rested or be wheeled on the side supporting elements 226, 228 to be loaded and supported by the cycle 200. The platform 232 is movable between an operative position and a folded position. This allows the platform 232 to be moved in and out of the operative position depending on the type of cargo that needs to be transported.

The platform 232 comprises a first platform section 234 and a second platform section 236. In this embodiment, the first 234 and second 236 platform sections are each provided as a pair of platform elements. A first end of each platform element of the first platform section 234 is pivotally connected to an end of the head member 220 of the lower U-shaped frame of the supporting surface 218. A second end of each platform element of the first platform section 234 is pivotally connected to a first end of a platform element of the second platform section 236. In other embodiments, the first platform section 234 may be hingedly connected to the head member 220, and the second platform section 236 may be hingedly connected to the first platform section 234.

A ramp 238 is provided and connected to a second end of each platform element of the second platform section 236. The length of the ramp 238 extends between the side members 222, 224 of the lower U-shaped frame. The ramp 238 allows cargo to be pushed or wheeled more easily onto the platform 232 and thus, the cycle 200.

Each platform element of the first 234 and second 236 platform sections is disposed and abuts a side of the side members 222, 224 of the lower U-shaped frame, when in the operative position. The platform elements have a longer width than the side supporting elements 226, 228. Thus, the space or distance between the pairs of platform elements is shorter than the space or distance between the side supporting elements 226, 228. This allows cargos that cannot be supported by the side supporting elements 226, 228 to be supported by the platform 232.

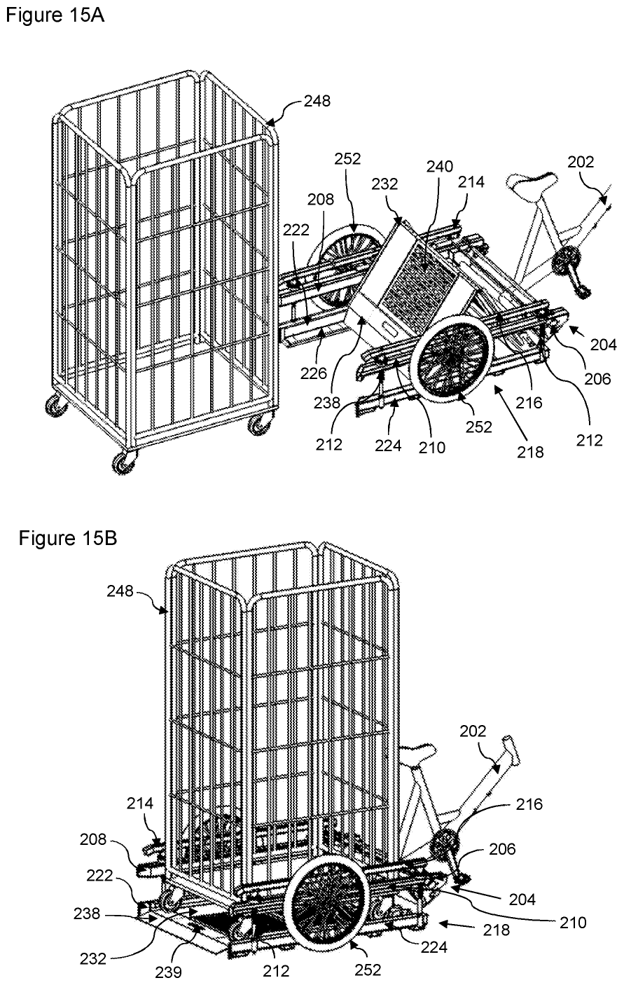

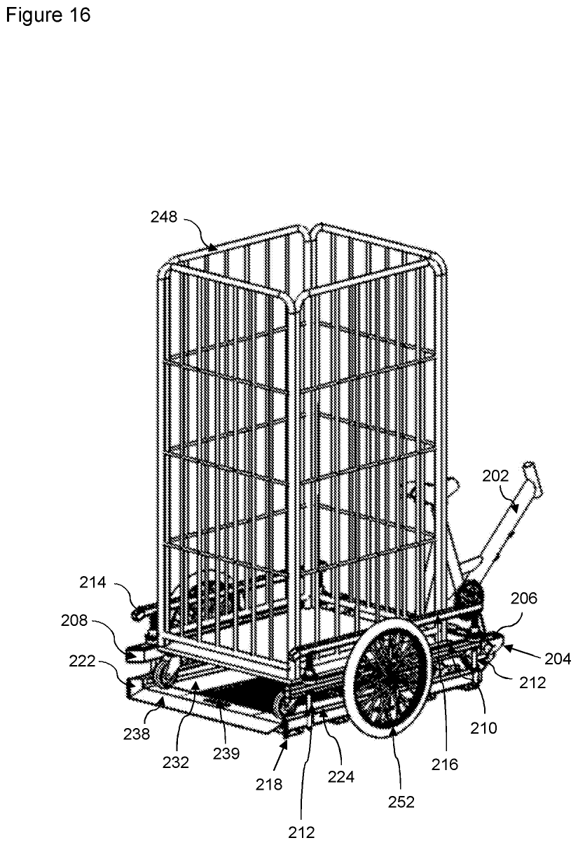

In FIGS. 10A to 16, a rod extends between the first 234 and second 236 platform sections and pivotally attaches the pair of platform elements of the first platform section 234 with the pair of platform elements of the second platform sections 236. However, as shown in FIGS. 17, two separate rods can be used to pivotally attach the platform elements of the first 234 and second 236 platform sections. A removably attachable cover 240 can be provided in the space between the pairs of platform elements as shown in FIGS. 15A to 16. A surface of the removably attachable cover 240 lies flush with surfaces of the first 234 and second 236 platform sections. This allows very small cargos or cargos with central wheels for example, to rest evenly on the platform 232.

In the operative position, the platform 232 lies or rests on the side 226, 228 and front 230 supporting elements. In the folded position, the first platform section 234 extends from the head member 220 of the lower U-shaped frame towards a substantially upwards direction, and the second platform section 236 extends from the pivotal connection with the first platform section 234 towards a downwards direction i.e., towards the head member 220 or side members 222, 224 of the lower U-shaped frame of the supporting surface 218. The first platform section 234 and the second platform section 236 lie substantially perpendicularly to the side members 222, 224 of the lower U-shaped frame, when in the folded positions. The ramp 238 is disposed between front ends of the side members 222, 224 of the lower U-shaped frame, when in the folded position.

The ramp 238 comprises a front portion and a rear portion. The front portion of the ramp 238 lies in a plane parallel with the second platform section 236. The rear portion of the ramp 238 extends in a direction substantially diagonal to the front portion. In the operative position, the rear portion of the ramp 238 extends in a diagonal direction from the first portion towards the ground. In the folded position, the rear portion of the ramp 238 extends in a diagonal direction from the first portion of the ramp towards the first platform section 234. An aperture 239 is provided in a central portion of the front portion of the ramp 238 thereby forming a handle for a person to move the platform 232 in the operative and folded positions. However, in other embodiments such as the one shown in FIG. 18, a handle may not be provided.

In other embodiments such as the one shown in FIG. 18, the length of the side members 222, 224 of the lower U-shaped frame may be longer than the length of the side members 208, 210 of the U-shaped rear section 204 and the length of the side bars 214, 216 of the movable lifting apparatus.

The jacks 212 are synchronised to move the movable lifting apparatus i.e., the pair of side bars 214, 216 and supporting surface 218 upwardly and downwardly with respect to the U-shaped rear section 204. This thereby raises the cargo engaged with the cycle 200 to the raised position for transport and lowers the cargo to the lowered position after transport.

In FIG. 10A, a substantially rectangular wheeled cargo pod 242 with an open top carrying a load, is positioned at the rear of the cycle 200. The movable lifting apparatus is disposed in a lowered position, ready to receive the cargo pod 242. The cargo pod 242 is wheeled over the chamfered ends of the side supporting elements 226, 228 of the supporting surface 218 and is pushed within the space between the side members 208, 210 of the U-shaped rear section 204 of the cycle 200, until the side rails of the cargo pod 242 fully overlie respective side bars 214, 216, as shown in FIG. 10B. The cargo pod 242 is then lifted by the cycle 200 as shown in FIG. 11 wherein the jacks 212 move upwardly in unison to support and raise the cargo pod 342 in the raised position evenly.

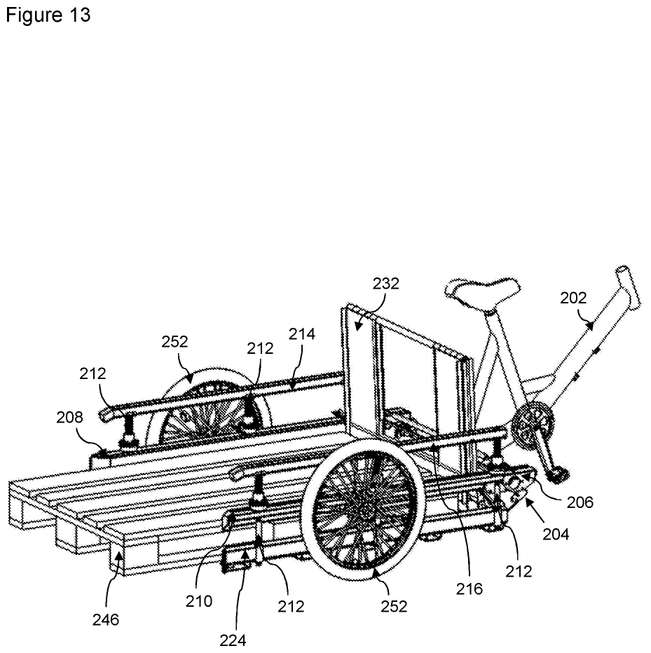

In FIGS. 12A and 12B, a forklift 244 is used to lift and position a pallet 246 at the rear of the cycle 200. The movable lifting apparatus is disposed in a lowered position, ready to receive the pallet 246. The forklift 244 sets the pallet 246 down on the supporting elements 226, 228, 230 of the supporting surface 218. Multiple pallets 246 may be placed on the cycle 200 for transport. For example, a second pallet can be placed on top of a first pallet. The upward movement of the jacks 212 moves the supporting surface 218 and the pallet 246 in the raised position for transport as shown in FIG. 13.

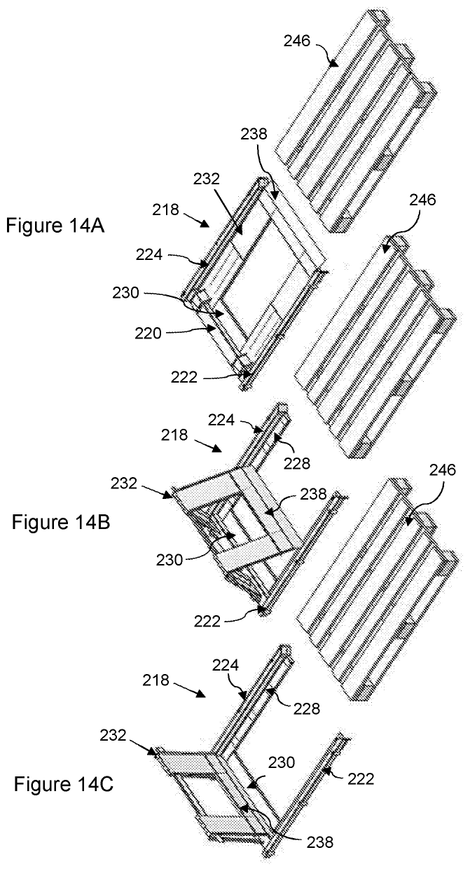

FIG. 14A to 14C show how the pallet 246 can be loaded on the cycle 200 in different ways. As shown in FIG. 14A, the platform 232 can be moved to the operative position so that the pallet 246 can be loaded and rested on the platform 232. Alternatively, the platform 232 can be moved to the folded position as shown in FIG. 14B. Once the platform 232 is in the folded position as shown in FIG. 24C, the pallet 246 can be loaded on the supporting elements 226, 228, 230 of the supporting surface 218.

In FIG. 15A, a cage 248 is positioned at the rear of the cycle 200. The movable lifting apparatus is disposed in a lowered position, ready to receive the cage 248. The platform 232 is moved to the operative position to ensure that the cage 248 is well supported by the cycle 200. The cage 248 is wheeled over the ramp 238 and pushed on the platform 232 within the space between the side members 208, 210 of the U-shaped rear section 204 of the cycle 200, as shown in FIG. 15B. The upward movement of the jacks 212 allows the cage 248 to be lifted in the raised position for transport as shown in FIG. 16.

In some embodiments, a lifting means housing 250 can be provided for covering and protecting toothed belt or sprockets and chains of the jacks 212. For example, as shown in FIGS. 18 and 19, a lifting means housing 250 can be provided between a side bar 214, 216 and a respective side member 208, 210 of the U-shaped rear section 204.

As shown in FIGS. 10A to 16, the rear wheels 252 are mounted substantially at the mid-point or slightly offset from the mid-point towards the rear of the movable lifting apparatus such that they support the majority of weight of a cargo, which may be positioned in the U-shaped rear section 204.

The embodiments described above are provided by way of example only, and various changes and modifications will be apparent to persons skilled in the art without departing from the scope of the present invention as defined by the appended claims.

1-25. (canceled)

26. A cycle for carrying cargo comprising:
a cycle frame having a front section mounting a steerable front wheel and a U-shaped rear section having a first head member and first side members, with at least one rear wheel being mounted to each side member;
a space disposed between the first side members and rear wheels; and
powered lifting means provided along the first side members and including a movable lifting apparatus, the powered lifting means being configured to move the movable lifting apparatus upwardly and/or downwardly with respect to the U-shaped rear section for engaging with and lifting cargo positioned in the space.

27. The cycle as claimed in claim 26, wherein the movable lifting apparatus includes a pair of side bars disposed substantially above the first side members of the U-shaped rear section.

28. The cycle as claimed in claim 26, wherein the movable lifting apparatus includes a supporting surface disposed substantially below the U-shaped rear section.

29. The cycle as claimed in claim 28, wherein the supporting surface comprises a lower U-shaped frame having a second head member and second side members, and comprises a pair of side supporting elements.

30. The cycle as claimed in claim 29, wherein each side supporting element is connected to a respective second side member of the lower U-shaped frame.

31. The cycle as claimed in claim 29, wherein an end of at least one of the side supporting elements is chamfered downwardly at an angle from front to rear forming a side ramp.

32. The cycle as claimed in claim 29, wherein the supporting surface comprises a front supporting element, the front supporting element being connected to the second head member of the lower U-shaped frame.

33. The cycle as claimed in claim 28, wherein the supporting surface includes a platform including a ramp, the ramp including a handle in a form of an aperture.

34. The cycle as claimed in claim 29, wherein the supporting surface comprises a front supporting element and includes a platform, the platform being movable between an operative position and a folded position and rests on the pair of side supporting elements and/or the front supporting element when in the operative position.

35. The cycle as claimed in claim 28, wherein the supporting surface includes a platform comprising a first platform section and a second platform section, the first platform section and second platform section being pivotally connected to each other.

36. The cycle as claimed in claim 29, wherein the supporting surface includes a platform comprising a first platform section and a second platform section, the first platform section being pivotally connected to the second head member of the lower U-shaped frame.

37. The cycle as claimed in claim 36, wherein the platform comprises a first platform section and a second platform section, the first platform section and the second platform section lying substantially perpendicularly to a length of the second side members of the lower U-shaped frame, when in a folded position.

38. The cycle as claimed in claim 26, wherein the powered lifting means is driven by a motor.

39. The cycle as claimed in claim 26, wherein the powered lifting means is a plurality of jacks.

40. The cycle as claimed in claim 39, wherein the plurality of jacks is screw jacks or screw threaded rods extending above and below the first side members of the U-shaped rear section.

41. The cycle as claimed in claim 40, wherein the movable lifting apparatus includes a pair of side bars disposed substantially above the first side members of the U-shaped rear section and a supporting surface disposed substantially below the U-shaped rear section, and wherein a first end of each screw jack or screw threaded rod is connected to one of the side bars of the movable lifting apparatus and a second end of each screw jack or screw threaded rod is connected to the supporting surface of the movable lifting apparatus.

42. The cycle as claimed in claim 39, wherein the plurality of jacks is synchronised to move the movable lifting apparatus upwardly and/or downwardly with respect to the U-shaped rear section.

43. The cycle as claimed in claim 39, wherein each of the plurality of jacks on one first side member of the U-shaped rear section is aligned with a respective one of the plurality of jacks on the other first side member.

44. The cycle as claimed in claim 39, wherein a motor is provided for each of the plurality of jacks for separately driving each of the plurality of jacks, a processor connected to each of the motors, and an encoder or other feedback means configured to provide feedback from one or more of the motors to the processor for the processor to coordinate a movement of the plurality of jacks based on the feedback.

45. The cycle as claimed in claim 27, wherein a housing is provided and disposed between each side bar and each first side member of the U-shaped rear section.
